(19) United States
(12) Patent Application Publication
(10) Pub. No.: US 2020/0092339 A1
(43) Pub. Date: Mar. 19, 2020

(54) PROVIDING DEVICE CONTROL INSTRUCTIONS FOR INCREASING CONFERENCE PARTICIPANT INTEREST BASED ON CONTEXTUAL DATA ANALYSIS

(71) Applicant: INTERNATIONAL BUSINESS MACHINES CORPORATION, Armonk, NY (US)

(72) Inventors: Sarbajit K. Rakshit, Kolkata (IN); John M. Ganci, JR., Raleigh, NC (US); James E. Bostick, Cedar Park, TX (US); Martin G. Keen, Cary, NC (US)

(21) Appl. No.: 16/132,998

(22) Filed: Sep. 17, 2018

(51) Int. Cl. H04L 29/06; G10L 25/63; G10L 21/003; H04L 12/18; G06K 9/00

(52) U.S. Cl. CPC H04L 65/1083; G10L 25/63; G06K 9/00335; H04L 12/1827; G10L 21/003

(57) ABSTRACT

A computer-implemented method includes: monitoring, by a computing device, contextual data associated with a user during a conference; determining, by the computing device, a user interest level based on the monitoring the contextual data; determining, by the computing device, a control instruction to provide to a user device associated with the user based on the user's interest level, wherein the control instruction causes the user device to modulate a voice of a speaker in the conference; and outputting, by the computing device, the control instruction to cause the user device to execute the control instruction.

### BACKGROUND

The present invention generally relates to providing device control instructions and, more particularly, to providing device control instructions for increasing conference participant interest based on contextual data analysis.

User devices are often used to host or attend a conference, such as a teleconference, web conference, video conference, etc. Collaborative teleconference tools allow for the live exchange and mass articulation of information among several persons and machines remote from one another but linked by a telecommunications system including Internet or web-based systems. Terms such as audio conferencing, telephone conferencing and phone conferencing are also sometimes used to refer to teleconferencing systems.

### SUMMARY

In an aspect of the invention, a computer-implemented method includes: monitoring, by a computing device, contextual data associated with a user during a conference; determining, by the computing device, a user interest level based on the monitoring the contextual data; determining, by the computing device, a control instruction to provide to a user device associated with the user based on the user's interest level, wherein the control instruction causes the user device to modulate a voice of a speaker in the conference; and outputting, by the computing device, the control instruction to cause the user device to execute the control instruction.

In an aspect of the invention, there is a computer program product comprising a computer readable storage medium having program instructions embodied therewith. The program instructions are executable by a computing device to cause the computing device to: receive identification information for a participant in a conference; monitor contextual data associated with the identified participant; determine a level of the participant based on the monitoring the contextual data; determine a custom control instruction to provide to a user device associated with the participant based on the participant's interest level, wherein the custom control instruction is customized for the participant; and output the custom control instruction to cause the user device to execute the custom control instruction.

In an aspect of the invention, a system includes: a processor, a computer readable memory and a computer readable storage medium associated with a computing device; program instructions to receive identification information for a participant in a conference; program instructions to monitor contextual data associated with the identified participant; program instructions to determine a level of the participant based on the monitoring the contextual data; program instructions to predict a subsequent spoken word based on the contextual data; program instructions to determine a custom control instruction to provide to a user device associated with the participant based on the participant's interest level and the subsequent spoken word, wherein the custom control instruction is customized for the participant; and program instructions to output the custom control instruction to cause the user device to execute the custom control instruction. The program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation and environment in accordance with aspects of the present invention

FIG. 5 shows an example flowchart of a process for generating custom control instructions for user devices to maintain and/or provoke the interest of a participant in a conference or presentation in accordance with aspects of the present invention.

### DETAILED DESCRIPTION

The present invention generally relates to providing device control instructions and, more particularly, to providing device control instructions for increasing conference participant interest based on contextual data analysis. During a presentation or conference (e.g., a phone call, teleconference, web/video conference, live presentation, etc.), if a speaking party does not maintain contextual voice modulation during their speech the speaker's voice may become monotonous, and as a result a listening party may lose interest in the conversation. That is, contextual voice modulation may keep participants or listeners engaged in a presentation or conversation by preventing a presenter or speaker from becoming monotonous. Advantageously, aspects of the present invention provide contextual-based voice modulation so that a listening party is engaged with respect to the spoken content delivered by the speaker.

In embodiments, aspects of the present invention provide control instructions to a user device (e.g., telephone, desktop/laptop computer, tablet, smartphone, etc.) in which the control instructions modulate the speaker's voice on a listener's (e.g., conference participant's) user device in a manner that increases the interest level of the listener. Additionally, or alternatively, the control instruction includes an instruction to adjust the tempo of the speaker's voice, pause the speaker's voice during conversation, provide haptic feedback to the participant, provide a visual alert or animation, modulate the speaker's tone, volume, accent, etc.

In embodiments, the control instructions are determined based on contextual data that is used to predict subsequent words that will be spoken in a conversation. In embodiments, the control instructions are determined based on contextual data that indicates the participant's interest level. In embodiments, contextual data includes spoken words, body language/expressions/emotions/biometrics of the speaker/participant, tone, tempo, etc.

In embodiments, the control instructions are determined based on a set of criteria specific to a particular individual based on actions that have historically increased the individual's interest level. In this way, customized control instructions are determined for individual users/participants to maximize the interest level of each user based on the historical response and effectiveness of different control instructions/voice modulation techniques. As described herein, the criteria are user-specific and is updated over time using machine learning and cognitive computing techniques. For example, the effectiveness of control instructions is determined such that criteria are updated to result in more effective control instructions being implemented and output to participant user devices.

In embodiments, control instructions are provided to a speaker as well as a listener (e.g., to direct the speaker to modulate their voice in a specific manner, adjust tempo, insert a pause, etc.). In embodiments, aspects of the present invention provide a report that identifies participant interest levels at different points in time during a presentation. In embodiments, aspects of the present invention provide different control instructions to different participants' user devices (e.g., via different audio streams, network sessions, etc.). In embodiments, control instructions are provided in real-time during a teleconference or presentation. Additionally, or alternatively, control instructions are provided during playback of a pre-recorded presentation, teleconference, webcast, audiobook, video, and/or audio presentation.

Aspects of the present invention improve the functioning of a computing device itself by incorporating a system into the computing device to perform functions that were not previously possible. For example, aspects of the present invention incorporate a system for controlling a user device to maximize the interest level of listeners/participants in a conference. In this regard, aspects of the present invention provide a specific solution to a specific problem by controlling a user device to maximize the interest level of listeners/participants in a conference to address the problem of low conference participant interest level and involvement. Further, aspects of the present invention improve the field of communications to solve a problem known in the art of increasing presentation participant interest level.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

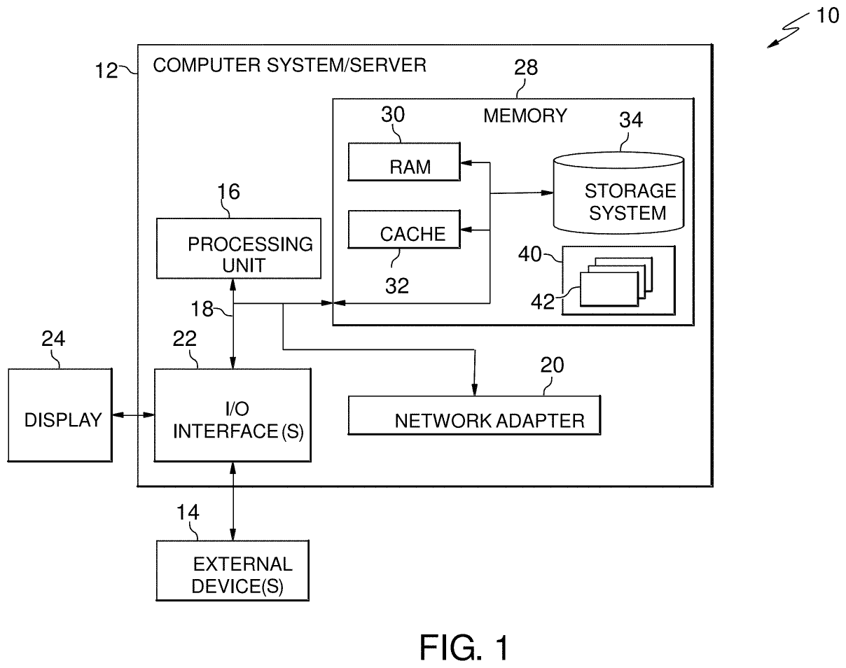

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

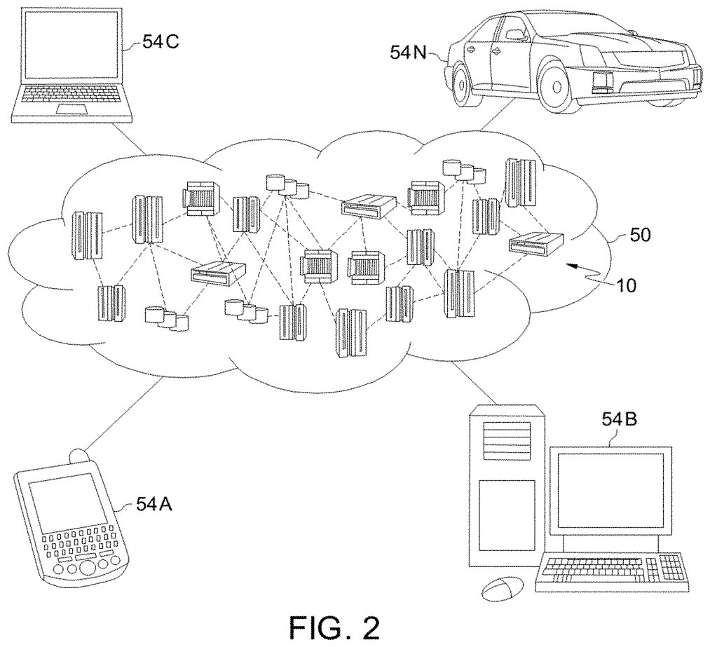

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

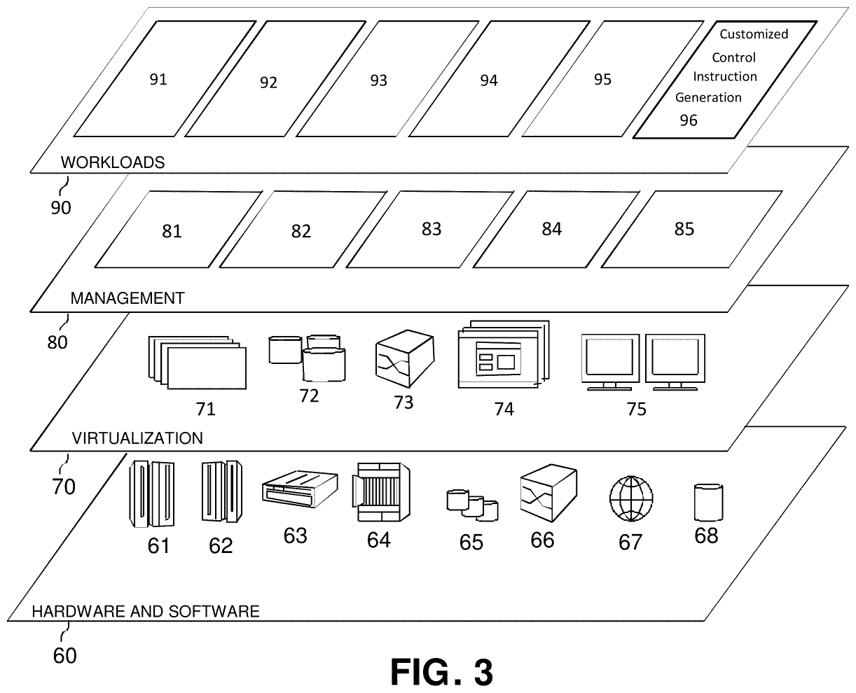

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customized control instruction generation 96.

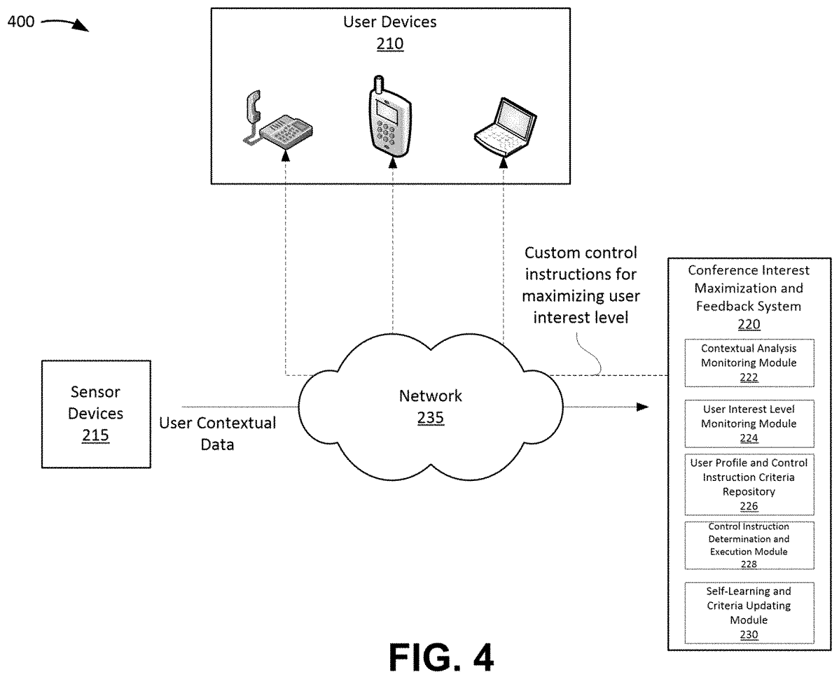

Referring back to FIG. 1, the program/utility 40 may include one or more program modules 42 that generally carry out the functions and/or methodologies of embodiments of the invention as described herein (e.g., such as the functionality provided by customized control instruction generation 96). Specifically, the program modules 42 may monitor user contextual data, determine and monitor user interest level based on the contextual data, predict subsequent spoken words based on the contextual data, determine a control instruction for maximizing participant interest, output the control instruction, and apply machine learning by determining the effectiveness of the control instruction and updating the control instruction criteria based on the effectiveness. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a conference interest maximization and feedback system 220 as shown in FIG. 4.

FIG. 4 shows an overview of an example implementation and environment in accordance with aspects of the present invention. As shown in FIG. 4, environment 400 includes user devices 210, sensor devices 215, a conference interest maximization and feedback system 220, and a network 235. In embodiments, one or more components in environment 400 may correspond to one or more components in the cloud computing environment of FIG. 2. In embodiments, one or more components in environment 400 may include the components of computer system/server 12 of FIG. 1.

The user devices 210 each include a computing device that communicates via network 235. A user or participant of a conference may use a user device 210 to participate in the conference. For example, in embodiments, the user devices 210 includes a smartphone, tablet device, laptop computer, desktop computer, telephone system, or the like.

The sensor devices 215 include one or more camera devices, and/or sensors that gather contextual data for a user or participant of the conference. In embodiments, the sensor devices 215 may be implemented within wearable computing devices, user devices 210, etc. In embodiments, contextual data includes spoken words, body language, expressions, emotions, and/or biometrics of the speaker/participant, tone, tempo, etc.

The conference interest maximization and feedback system 220 includes one or more computing/server devices (e.g., computer system/server 12 of FIG. 1). In embodiments, the conference interest maximization and feedback system 220 receives user contextual data from the sensor devices 215 and generates custom control instructions for maximizing user interest level. In embodiments, the conference interest maximization and feedback system 220 includes a contextual analysis monitoring module 222, a user interest level monitoring module 224, a user profile and control instruction criteria repository 226, a control instruction determination and execution module 228, and a self-learning and criteria updating module 230 that process the contextual data to generate the custom control instructions as described in greater detail herein.

The contextual analysis monitoring module 222 includes a program module (e.g., program module 42 of FIG. 1) that receives contextual data from one or more sensor devices 215 during a conference. As described herein, in embodiments, contextual data includes spoken words, body language, expressions, emotions, biometrics of the speaker/participant, tone, tempo, etc. In embodiments, the contextual analysis monitoring module 222 receives and monitors the contextual data received by the sensor devices 215 and performs contextual analysis of the contextual data to predict subsequent spoken words in a conversation based on the contextual data. For example, the contextual analysis monitoring module 222 uses natural language processing techniques, tone analysis, sentiment analysis, etc. to perform the contextual analysis by analyzing the spoken words and determining the likely subsequent spoken words that will be spoken next. Additionally, or alternatively, the contextual analysis monitoring module 222 predicts subsequent spoken words based on the speaker's historical speaking habits/historical conversations, etc.

The user interest level monitoring module 224 includes a program module (e.g., program module 42 of FIG. 1) that determines and monitors a user's interest level based on the contextual data. For example, the user interest level monitoring module 224 processes the contextual data to determine the user's interest level by applying any suitable emotion or interest determination technique (e.g., facial recognition techniques, biometrics analysis, voice analysis, body language analysis, etc.).

The user profile and control instruction criteria repository 226 includes a data storage device (e.g., storage system 34 of FIG. 1) that stores a user profile for the user and criteria that defines control instructions to generate/output to a user device 210 associated with the user. In embodiments, the user profile identifies information that indicates the types of control instructions that have historically been effective at engaging the user's interest in a conversation based on the user's different emotions, contextual data, and interest levels. In this way, custom control instructions are generated for different users who may respond differently to different control instructions for different situations. As an example, one user may respond more effectively to a vibration on their smartphone whereas another user may respond more effectively to an audible alert and blinking alert on their tablet device. As another example, one user may respond more effectively when a speaker's voice tone/voice tempo is modulated in one manner whereas another user may respond more effectively when a speaker's voice tone/voice tempo is modulated in another manner. In embodiments, the criteria are based on the user's contextual data, the user interest level, and/or the contextual analysis performed by the contextual analysis monitoring module 222 (e.g., predicted subsequent spoken words/parts of speech of a predictive subsequent word). As described herein the user profile and control instruction criteria repository 226 is updated by the self-learning and criteria updating module 230 based on the effectiveness of control instructions. In this way, the conference interest maximization and feedback system 220 “self-learns” and improves the control instructions in a manner most effectively provokes the user's interest.

The control instruction determination and execution module 228 includes a program module (e.g., program module 42 of FIG. 1) that determines a control instruction to provide to one or more user devices 210 associated with a user. As described herein, the control instruction determination and execution module 228 determines the control instruction by mapping the user's contextual data, the user's interest level, and/or the contextual analysis with the criteria stored by the user profile and control instruction criteria repository 226. The control instruction determination and execution module 228 identifies which control instruction matches the criteria from the user profile and control instruction criteria repository 226, and executes the corresponding control instruction by outputting the control instruction to one or more user devices 210 associated with the user. As described herein, example control instructions include an instruction to modulate the speaker's voice on the listening user's user device 210 in a manner that increases the interest level of the listener (e.g., by controlling the audio output on the user device 210 to modulate the speaker's voice). Additionally, or alternatively, the control instruction includes an instruction to adjust the tempo of the speaker's voice, pause the speaker's voice during conversation, provide haptic feedback to the participant via the user device 210, provide a visual alert or animation on the user device 210, modulate the speaker's tone, volume, accent, etc. on the user device 210. As described herein, the control instruction determination and execution module 228 outputs the control instruction to a specific user device 210 associated with the user via different communications channels (e.g., IP-based sessions/streams, telephone audio streaming sessions, etc.). In this way, different custom control instructions can be provided to different users using different user devices 210.

The self-learning and criteria updating module 230 includes a program module (e.g., program module 42 of FIG. 1) that determines the effectiveness of a control instruction provided to a user device 210. For example, the self-learning and criteria updating module 230 determines the effectiveness of a control instruction based on the user interest level (e.g., determined by the user interest level monitoring module 224 and determined based on the contextual data) after the control instruction is outputted and executed. If a control instruction is relatively ineffective (e.g., if the user's interest level is below a threshold), the self-learning and criteria updating module 230 notifies the control instruction determination and execution module 228, and the control instruction determination and execution module 228 provides a different control instruction in an attempt to provide the user's interest. Further, the self-learning and criteria updating module 230 modifies the control instruction criteria (e.g., stored by the user profile and control instruction criteria repository 226) to reflect the control instructions that more effectively provoked the user's interest. In this way, the conference interest maximization and feedback system 220 “self learns” and improves the control instructions in a manner most effectively provokes the user's interest.

As shown in FIG. 4, the user devices 210, the sensor devices 215, and the conference interest maximization and feedback system 220 communicate via the network 235. The network 235 may include network nodes, such as network nodes 10 of FIG. 2. Additionally, or alternatively, the network 235 may include one or more wired and/or wireless networks. For example, the network 235 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 235 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4. Also, in some implementations, one or more of the devices of the environment 400 may perform one or more functions described as being performed by another one or more of the devices of the environment 400. Devices of the environment 400 may interconnect via wired connections, wireless connections, or a combination of wired and wireless connections.

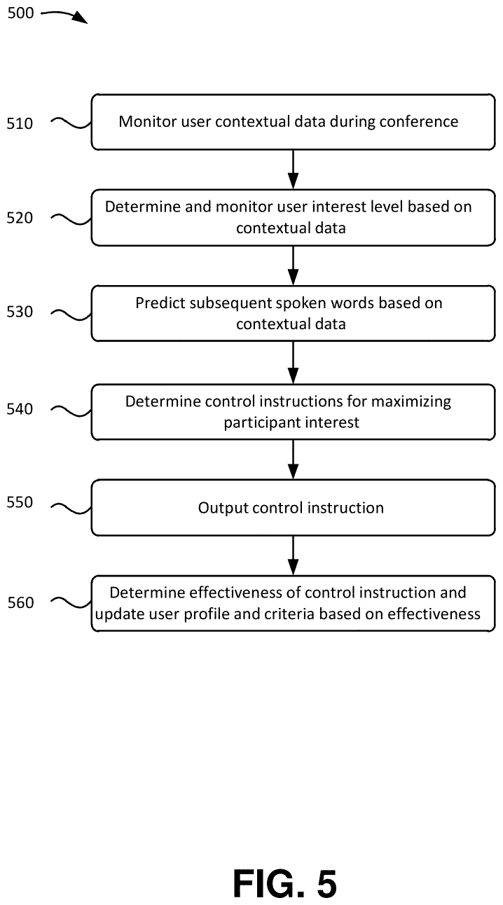

FIG. 5 shows an example flowchart of a process for generating custom control instructions for user devices to maintain and/or provoke the interest of a participant in a conference or presentation. The steps of FIG. 5 may be implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

As shown in FIG. 5, process 500 includes monitoring user contextual data during a conference (step 510). For example, as described above with respect to the contextual analysis monitoring module 222, the conference interest maximization and feedback system 220 receives contextual data from one or more sensor devices 215 during a conference. As described herein, in embodiments, contextual data includes spoken words, body language, expressions, emotions, biometrics of the speaker/participant, tone, tempo, etc. In embodiments, the conference interest maximization and feedback system 220 identifies a specific user associated with the contextual data (e.g., based on user login information, facial recognition, voice recognition, user device identification information, etc.

Process 500 also includes determining and monitoring user interest level based on the contextual data (step 520). For example, as described above with respect to the user interest level monitoring module 224, the conference interest maximization and feedback system 220 monitors the user's interest level based on the contextual data. For example, the conference interest maximization and feedback system 220 processes the contextual data to determine the user's interest level by applying any suitable emotion or interest determination technique (e.g., facial recognition techniques, biometrics analysis, voice analysis, body language analysis, eye focus/eye behavior analysis etc.). In this way, user interest can be determined and whether interest provocation is needed (e.g., whether the user and/or surrounding users are engaged, or are feeling bored/sleepy, etc.)

Process 500 further includes predicting subsequent spoken words based on contextual data (step 530). For example, as described above with respect to the contextual analysis monitoring module 222, the conference interest maximization and feedback system 220 predicts subsequent spoken words based on contextual analysis of the contextual data. In embodiments, the conference interest maximization and feedback system 220 uses natural language processing techniques to perform the contextual analysis and predict subsequent spoken words that the speaker is predicted to speak based on the speaker's tone, tempo, content/context of previously spoken words, etc. Additionally, or alternatively, the conference interest maximization and feedback system 220 predicts subsequent spoken words based on the speaker's historical speaking habits/historical conversations. As an example, the conference interest maximization and feedback system 220 predicts that the word “pizza” is going to be spoken after the word “pepperoni” based on natural language processing of the context of the speaker's conversation, the speaker's historical conversations, the speaker's tone, etc.

Process 500 also includes determining control instructions for maximizing participant interest (step 540). For example, as described above with respect to the control instruction determination and execution module 228, the conference interest maximization and feedback system 220 determines control instructions for maximizing participant (e.g., user) interest. In embodiments, the conference interest maximization and feedback system 220 determines the control instruction by mapping the user's contextual data, the user's interest level, and/or the contextual analysis with the criteria stored by the user profile and control instruction criteria repository 226. The conference interest maximization and feedback system 220 identifies which control instruction matches the criteria from the user profile and control instruction criteria repository 226, and executes the corresponding control instruction by outputting the control instruction to one or more user devices 210 associated with the user. In embodiments, the conference interest maximization and feedback system 220 determines a control instruction when the user's interest level falls below a particular threshold. In this way, the conference interest maximization and feedback system 220 takes action to provoke and/or maintain the user's interest when the user's interest is considered low.

In an embodiment (e.g., in which aspects of the present invention are implemented in a live, in-person conference), conference interest maximization and feedback system 220 determines an aggregate interest level of the participants in the conference by determining the interest level of each individual participant (e.g., in accordance with process steps 510 and 520). The conference interest maximization and feedback system 220 determines a control instruction (e.g., to control an audio output system that has the ability to modulate the presenter's/speakers voice and is implemented in a conference room where a conference is taking place. The control instruction is determined for increasing and/or maintaining the interest level of the group of participants. In other words, the conference interest maximization and feedback system 220 determines control instructions for individual participants (e.g., based on the participant's interest level) and/or for a group of participants (e.g., based on the interest level of other participants).

Process 500 further includes outputting the control instruction (step 550). For example, as described above with respect to the control instruction determination and execution module 228, the conference interest maximization and feedback system 220 outputs the control instruction. In embodiments, conference interest maximization and feedback system 220 outputs the control instruction to a specific user device 210 associated with the user via different communications channels (e.g., IP-based sessions/streams, telephone audio streaming sessions, etc.). In this way, different custom control instructions can be provided to different users using different user devices 210 (e.g., users that may have special needs, or varying interest levels). Additionally, or alternatively, the control instruction is be provided to a group of user devices 210, or to an audio output system that has the ability to modulate the presenter's/speakers voice.

Process 500 also includes determining the effectiveness of control instruction and update user profile and criteria based on effectiveness (step 560). For example, as described above with respect to the self-learning and criteria updating module 230, the conference interest maximization and feedback system 220 determines the effectiveness of control instruction and update user profile and criteria based on effectiveness. In embodiments, the conference interest maximization and feedback system 220 determines the effectiveness of a control instruction based on the user interest level (e.g., determined by the user interest level monitoring module 224 and determined based on the contextual data) after the control instruction is outputted and executed. Further, the conference interest maximization and feedback system 220 modifies the control instruction criteria (e.g., stored by the user profile and control instruction criteria repository 226) to reflect the control instructions that more effectively provoked the user's interest. In this way, the conference interest maximization and feedback system 220 “self learns” and improves the control instructions in a manner most effectively provokes the user's interest.

In embodiments, aspects of the present invention generate a report that provides feedback to a speaker/presenter of times during a presentation in which user/participant interest was low, and the control instructions that were used to provoke the participants'/audience members' interest. In this way, the speaker/presenter is informed of actions that can be taken for future presentations to provoke/maintain the participants' interest (e.g., speaking louder, at a particular tempo, inserting pauses at certain points, etc.). For example, in embodiments, the conference interest maximization and feedback system 220 will continue to learn and teach the user/speaker to modulate voice to become an expert level speaker.

In embodiments, the conference interest maximization and feedback system 220 performs analysis of the historical voice data for a given user to self-learn appropriate times for voice modulation and pauses in speech. In embodiments, aspects of the present invention provide a system and method optimizing voice modulation including: receiving content of an audio presentation (e.g., similar to the process of step 510), receiving in real time audience feedback of the audio presentation (e.g., similar to the process of step 520), analyzing the content and audience feedback for an optimized voice modulation for the audio presentation of targeted user (e.g., similar to the process of steps 530 and 540), and modulating the audio in accordance with the analyzing step (e.g., similar to the process of step 550). In embodiments, the modulation is provided with consideration for special needs of audience/participant members.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
monitoring, by a computing device, contextual data associated with a user during a conference;
determining, by the computing device, a user interest level based on the monitoring the contextual data;
determining, by the computing device, a control instruction to provide to a user device associated with the user based on the user's interest level, wherein the control instruction causes the user device to modulate a voice of a speaker in the conference; and
outputting, by the computing device, the control instruction to cause the user device to execute the control instruction.

2. The computer-implemented method of claim 1, wherein the control instruction further includes at least one selected from the group consisting of:
an instruction to modulate a tone, volume, or accent of the speaker in the conference;
an instruction to adjust the tempo of the speaker's voice;
an instruction to pause the speaker's voice during conversation;
an instruction to provide haptic feedback to the user via the user device; and
an instruction to provide a visual alert or animation on the user device.

3. The computer-implemented method of claim 1, wherein the control instruction is a first control instruction, the method further comprising determining a second control instruction for a different user device associated with a different user, wherein the first control instruction and the second control instruction are different.

4. The computer-implemented method of claim 3, wherein the first control instruction and the second control instruction are provided by different communications channels.

5. The computer-implemented method of claim 1, wherein the control instruction is determined based on criteria that maps the control instruction to the user interest level.

6. The computer-implemented method of claim 5, further comprising determining an effectiveness of the control instruction and updating the criteria based on the effectiveness of the control instruction.

7. The computer-implemented method of claim 1, further comprising predicting a subsequent spoken word based on the monitoring the contextual data, wherein the control instruction is further based on the predicted subsequent spoken word.

8. The computer-implemented method of claim 1, wherein the conference includes at least one selected from the group consisting of:
a teleconference;
a live presentation;
a webcast;
a web/video conference; and
an audiobook.

9. The computer-implemented method of claim 1, wherein the contextual data is received from one or more sensors, wherein the contextual data comprises at least one selected from the group consisting of:
spoken words during the conference;
tone of the spoken words;
tempo of the spoken words;
user body language;
user expressions;
user eye behavior;
user emotions; and
user biometrics data.

10. The computer-implemented method of claim 1, wherein a service provider at least one of creates, maintains, deploys and supports the computing device.

11. The computer-implemented method of claim 1, wherein the monitoring the contextual data, the determining the user interest level, the determining the control instruction, and the outputting the control instruction are provided by a service provider on a subscription, advertising, and/or fee basis.

12. The computer-implemented method of claim 1, wherein the computing device includes software provided as a service in a cloud environment.

13. The computer-implemented method of claim 1, further comprising deploying a system comprising providing a computer infrastructure operable to perform the monitoring the contextual data, the determining the user interest level, the determining the control instruction, and the outputting the control instruction.

14. A computer program product comprising a computer readable storage medium having program instructions embodied therewith, the program instructions executable by a computing device to cause the computing device to:
receive identification information for a participant in a conference;
monitor contextual data associated with the identified participant;
determine a level of the participant based on the monitoring the contextual data;
determine a custom control instruction to provide to a user device associated with the participant based on the participant's interest level, wherein the custom control instruction is customized for the participant; and
output the custom control instruction to cause the user device to execute the custom control instruction.

15. The computer program product of claim 14, wherein the custom control instruction includes at least one selected from the group consisting of:
an instruction to modulate a voice, tone, volume, or accent of a speaker in the conference;
an instruction to adjust the tempo of the speaker's voice;
an instruction to pause the speaker's voice during conversation;
an instruction to provide haptic feedback to the user device; and
an instruction to provide a visual alert or animation on the user device.

16. The computer program product of claim 14, wherein the control instruction is determined based on criteria mapping the control instruction to the user interest level.

17. The computer program product of claim 16, wherein the program instructions further cause the computing device to determine an effectiveness of the control instruction and updating the criteria based on the effectiveness of the control instruction.

18. The computer program product of claim 14, wherein the contextual data is received from one or more sensors, wherein the contextual data comprises at least one selected from the group consisting of:
spoken words during the conference;
tone of the spoken words;
tempo of the spoken words;
user body language;
user expressions;
user eye behavior;
user emotions; and
user biometrics data.

19. A system comprising:
a processor, a computer readable memory and a computer readable storage medium associated with a computing device;
program instructions to receive identification information for a participant in a conference;
program instructions to monitor contextual data associated with the identified participant;
program instructions to determine a level of the participant based on the monitoring the contextual data;
program instructions to predict a subsequent spoken word based on the contextual data;
program instructions to determine a custom control instruction to provide to a user device associated with the participant based on the participant's interest level and the subsequent spoken word, wherein the custom control instruction is customized for the participant; and
program instructions to output the custom control instruction to cause the user device to execute the custom control instruction,
wherein the program instructions are stored on the computer readable storage medium for execution by the processor via the computer readable memory.

20. The system of claim 19, wherein the custom control instruction includes at least one selected from the group consisting of:
an instruction to modulate a voice, tone, volume, or accent of a speaker in the conference;
an instruction to adjust the tempo of the speaker's voice;
an instruction to pause the speaker's voice during conversation;
an instruction to provide haptic feedback to the user device; and
an instruction to provide a visual alert or animation on the user device.
